(19) United States
(12) Patent Application Publication
(10) Pub. No.: US 2009/0115684 A1
(43) Pub. Date: May 7, 2009

(54) RECEIVING ANTENNA WITH A BENDABLE SUPPORT

(75) Inventor: Cheng-Si WANG, Hua Tan Hsiang (TW)

Correspondence Address: PATENTTM.US, P. O. BOX 82788, PORTLAND, OR, 97282-0788, US

(73) Assignee: TRANS ELECTRIC CO., LTD., Hua Tan Hsiang (TW)

(21) Appl. No.: 11/935,046

(22) Filed: Nov. 5, 2007

(51) Int. Cl. H01Q 3/02

(52) U.S. Cl. 343/882

(57) ABSTRACT

A receiving antenna with a bendable support has a body, a mounting bracket and a bendable device. The body receives electromagnetic signals and has a rear surface and a connecting fixture protruding from the rear surface. The mounting bracket has a base with a top surface and a mounting post protruding from the top surface of the base. The bendable device is rod-like, is semi-rigid and flexible and has a distal end and a proximal end. The proximal end and distal end connect respectively to the connecting fixture of the body and the mounting post of the mounting bracket. A person can adjust orientation of the body to the mounting bracket by bending the bendable device.

### BACKGROUND OF THE INVENTION

1. Field of Invention

The present invention relates to an antenna, and more particularly to a receiving antenna with a bendable support that is used for adjusting the orientation of the receiving antenna.

2. Description of the Related Art

With reference to FIG. 6, a conventional receiving antenna has a body (70) and a mounting bracket (80). The body (70) receives electromagnetic signals. The mounting bracket (80) has a connecting device (82) and a base (87). The connecting device (82) has two ends and a joint (822). Ends of the connecting device (82) connect respectively to the body (70) and the base (87). The base (87) is attached to a wall so orientation of the body (70) can be adjusted attitude by rotating and pivoting the joint (822).

However, the joint (822) is fragile and easily corrodes when mounted outside.

The present invention provides a receiving antenna to obviate or mitigate the shortcomings of the conventional receiving antenna.

### SUMMARY OF THE INVENTION

The primary objective of the present invention is to provide a robust receiving antenna with a bendable support.

The receiving antenna with a bendable support in accordance with the present invention has a body, a mounting bracket and a bendable device. The body receives electromagnetic signals and has a rear surface and a connecting fixture protruding from the rear surface. The mounting bracket has a base with a top surface and a mounting tube protruding from the top surface of the base. The bendable device is rod-like, is semi-rigid and flexible and has a distal end and a proximal end. The proximal end and distal end connect respectively to the connecting fixture of the body and the mounting post of the base. A person can adjust orientation of the body to the base by bending the bendable device.

Other objectives, advantages and novel features of the invention will become more apparent from the following detailed description when taken in conjunction with the accompanying drawings.

### BRIEF DESCRIPTION OF THE DRAWINGS

FIG. 1 is a front perspective view of a receiving antenna with a bendable support in accordance with the present invention;

FIG. 2 is a rear perspective view of the receiving antenna in FIG. 1;

FIG. 3 is an exploded rear perspective view of the receiving antenna in FIG. 2;

FIG. 4 is an operational front view of the receiving antenna in FIG. 1;

FIG. 5 is an operational side view of the receiving antenna in FIG. 1; and

FIG. 6 is a perspective view of a conventional receiving antenna in accordance with the prior art.

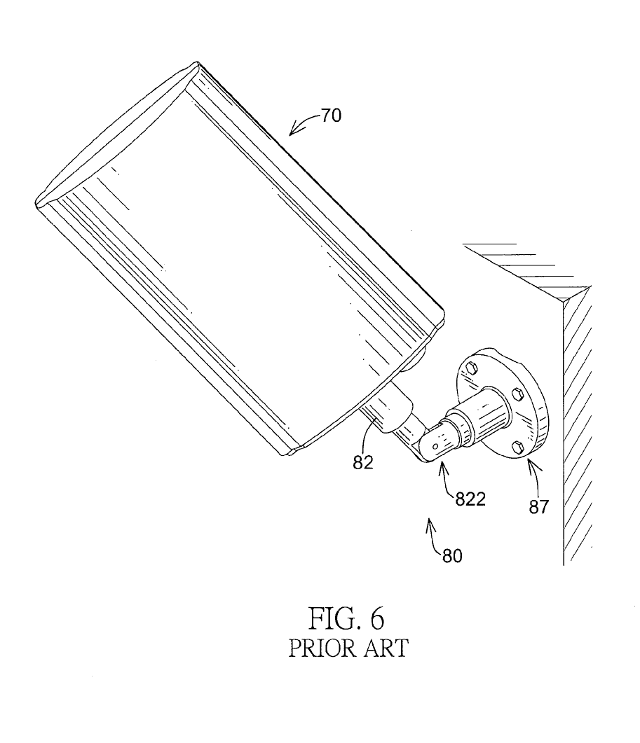

### DETAILED DESCRIPTION OF THE INVENTION

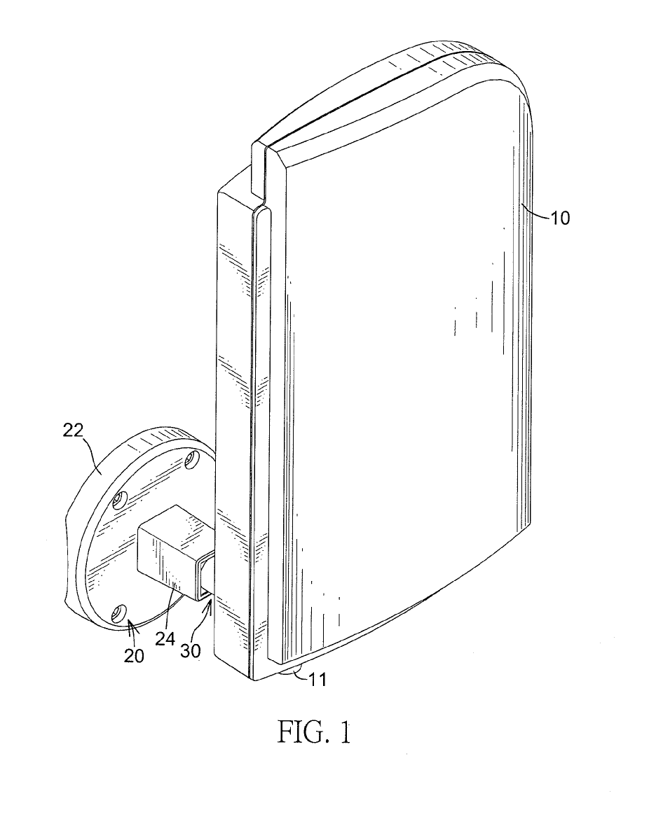

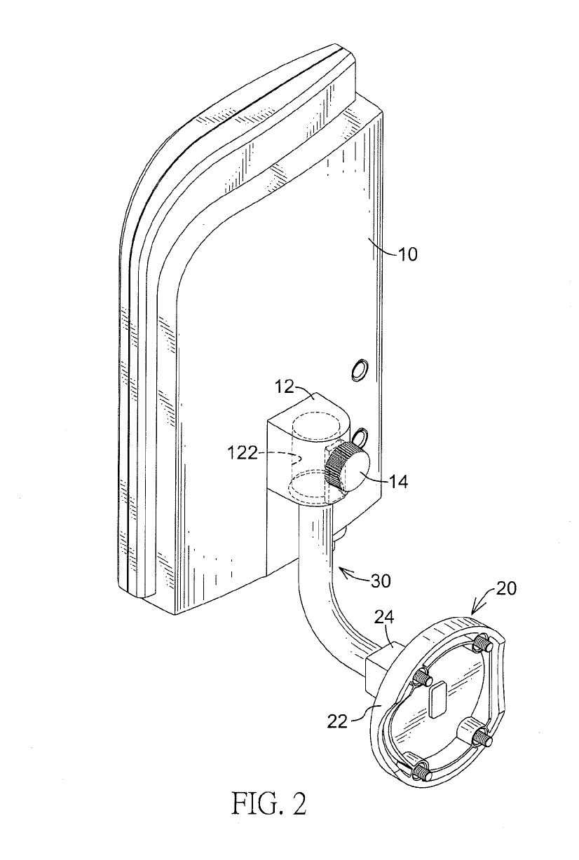

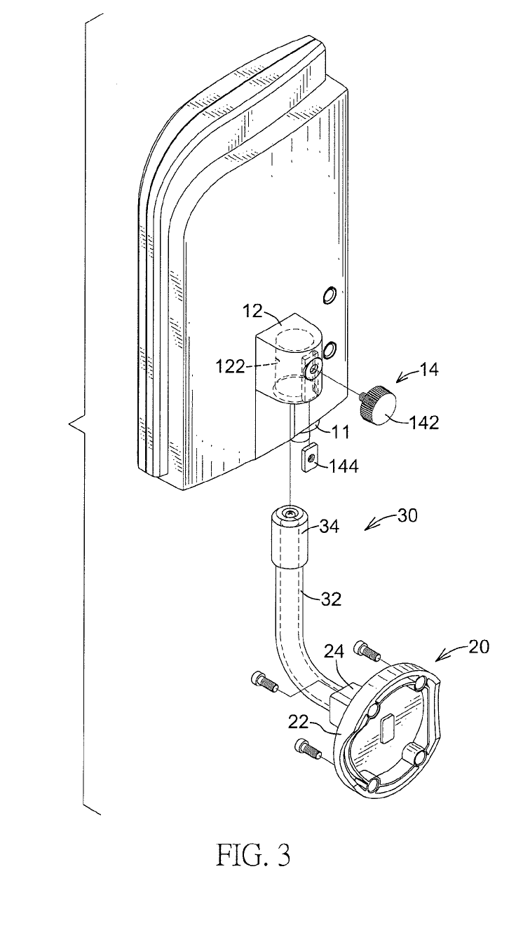

With reference to FIGS. 1, 2 and 3, a receiving antenna with a bendable support in accordance with the present invention comprises a body (10), a mounting bracket (20) and a bendable device (30).

The body (10) receives electromagnetic signals, may be rectangular and has a bottom edge, a rear surface, a signal output connector (11), a connecting fixture (12) and a fastener (14).

The signal output connector (11) is formed on the bottom edge of the body (10) and sends the electromagnetic signals to a television or the like.

The connecting fixture (12) is mounted on and protrudes from the rear surface of the body (10) and has a bottom surface, a front surface, a hole (122) and a fastener hole. The hole (122) is formed in the bottom surface of the connecting fixture (12). The fastener hole is formed in the front surface of the connecting fixture (12) and is perpendicular to and communicates with the hole (122).

The fastener (14) may have a nut (144) and a setscrew (142). The nut (144) is flat, is mounted inside the hole (122) and aligns with the fastener hole. The setscrew (142) has an inner end. The inner end of the setscrew (142) corresponds to and is mounted in the fastener hole and screws through the nut (144).

The mounting bracket (20) has a base (22) and a mounting post (24). The base (22) may be a disk and has a top surface. The mounting post (24) is tubular and is mounted coaxially on and protrudes from the top surface of the base (22).

The bendable device (30) has a flexible body (32) and may have a cap (34) and a plastic cover. The flexible body (32) is rod-like, is semi-rigid, may be ductile metal made such as an iron tube, iron rod, aluminum tube, aluminum rod or the like and has a distal end and a proximal end.

The distal end of the flexible body (32) is mounted coaxially in the mounting post (24) of the mounting bracket (20).

The proximal end mounted in the hole (122) in the connecting fixture (12) and is held securely in the connecting fixture (12) by the setscrew (142).

The cap (34) corresponds to, is mounted securely on and partially covers the proximal end of the bendable device body (32) and is clamped by the setscrew (142) when the proximal end is mounted in the hole (122) of the connecting fixture (12).

The plastic cover covers the flexible body (32) to protect the flexible body (32).

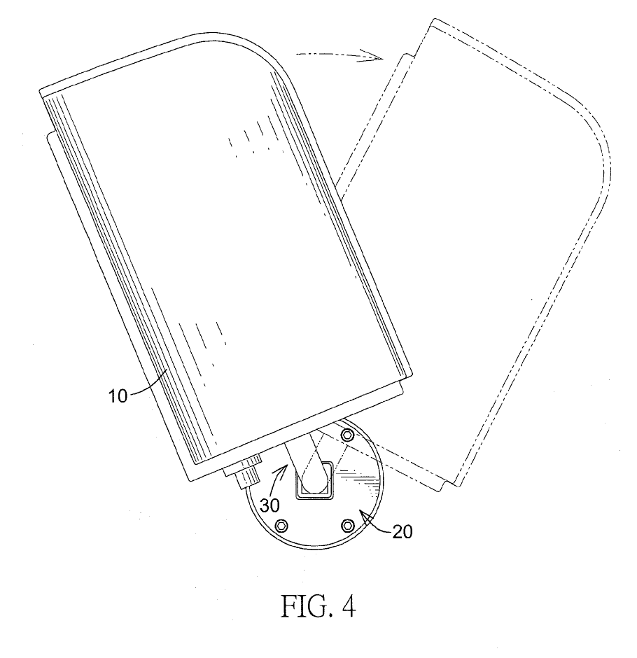

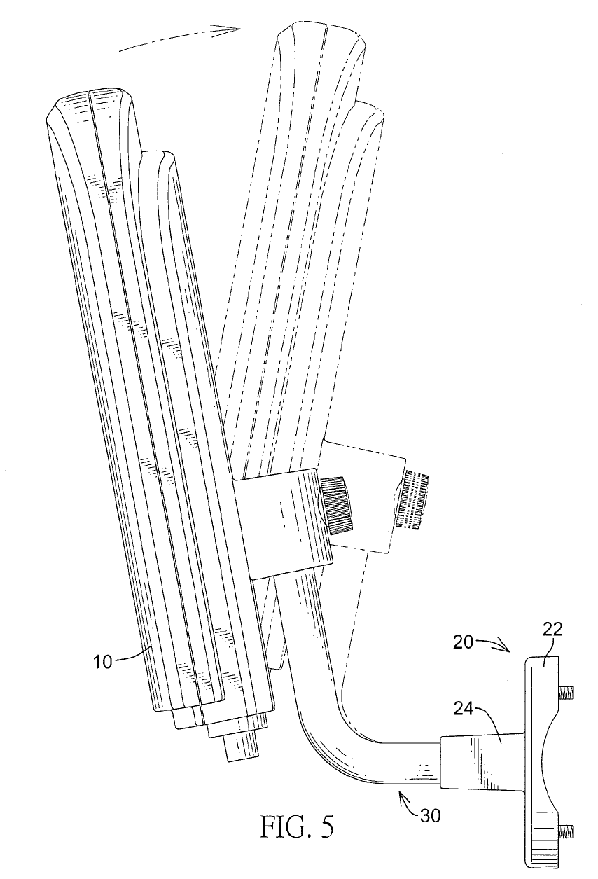

With further reference to FIGS. 4 and 5, orientation of the body (10) corresponding to the mounting bracket (20) is adjustable by bending the bendable device (30). The receiving antenna with a bendable support is suitable to be mounted outside because the bendable device (30) is a ductile metal tube or a ductile metal rod that is not easily to be broke or suffering corrosion.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A receiving antenna with a bendable support comprising
a body receiving electromagnetic signals and having
a bottom edge;
a rear surface;
a signal output connector being formed on the bottom edge of the body;
a connecting fixture being mounted on and protruding from the rear surface of the body and having
a bottom surface;
a front surface;
a hole being formed in the bottom surface of the connecting fixture; and
a fastener hole being formed in the front surface of the connecting fixture and being perpendicular to and communicating with the hole; and
a fastener having a setscrew having a fixing end corresponding to and being mounted in the fastener hole;
a mounting bracket having
a base having a top surface; and
a mounting post being tubular and being mounted coaxially on and protruding from the top surface of the base; and
a bendable device having flexible body being rod-like, being semi-rigid and having
a proximal end mounted in the hole in the connecting fixture and being held securely in the connecting fixture by the setscrew; and
a distal end being mounted coaxially in the mounting post of the mounting bracket.

2. The receiving antenna as claimed in claim 1, wherein
the fastener further has a nut being flat, being mounted inside the hole and aligning with the fastener hole; and
the inner end of the setscrew screws through the nut.

3. The receiving antenna as claimed in claim 1, wherein the bendable device further has
a cap corresponding to and being mounted securely on and partially covering the proximal end of the bendable device body and being clamped by the setscrew; and
a plastic cover covering the flexible body.

4. The receiving antenna as claimed in claim 2, wherein the bendable device further has
a cap corresponding to and being mounted securely on and partially covering the proximal end of the flexible body and being clamped by the setscrew; and
a plastic cover covering the flexible body.

5. The receiving antenna as claimed in claim 4, wherein the flexible body is an iron tube.

6. The receiving antenna as claimed in claim 4, wherein the bendable device body is an iron rod.

7. The receiving antenna as claimed in claim 4, wherein the flexible body is an aluminum tube.

8. The receiving antenna as claimed in claim 4, wherein the flexible body is an aluminum rod.
